(19) United States
(12) Patent Application Publication
(10) Pub. No.: US 2025/0343844 A1
(43) Pub. Date: Nov. 6, 2025

(54) SYSTEMS AND METHODS FOR LEVERAGING UNDERLYING OPERATING SYSTEM NETWORKING STACK IN A USER SPACE NETWORKING STACK WITH APPLICATION LAYER FUNCTIONALITY

(71) Applicant: Citrix Systems, Inc., Fort Lauderdale, FL (US)

(72) Inventors: Mohit Prakash Saxena, Bangalore (IN); Subhransu Chhotaray, Bangalore (IN); Akshay Budhauliya, Bangalore (IN); Praveen HM, Bangalore (IN)

(73) Assignee: Citrix Systems, Inc., Fort Lauderdale, FL (US)

(21) Appl. No.: 18/655,820

(22) Filed: May 6, 2024

(51) Int. Cl. H04L 69/163; H04L 69/16

(52) U.S. Cl. CPC H04L 69/163; H04L 69/161

(57) ABSTRACT

The disclosure describes systems and methods for leveraging the underlying operating system networking stack in a user space networking stack with application layer functionality. The processors can be configured to install a shim layer as a network driver for a user space application implementing a user space portion. The shim layer can use an operating system portion. The shim layer can facilitate a first transport layer connection handshake with the user space application to establish a transport layer connection with a remote device in the user space portion. The shim layer can receive from the operating system portion an event indicating the transport layer connection was established via a second transport layer connection handshake between the operating system portion and the remote device. The shim layer can facilitate, responsive to receiving the event, the first transport connection handshake with the user space application.

### FIELD OF THE DISCLOSURE

The present application generally relates to computer networking, including but not limited to systems and methods for leveraging underlying operating system networking stacks to facilitate data transfer within user space networking stack infrastructures with application layer or layer 7 (L7) functionality.

### BACKGROUND

Virtualized networks enable user space applications to implement custom layer 2 to layer 7 networking stacks. These custom networking stacks leverage elevated permissions for direct packet processing. However, as operating systems continuously add new features, they pose integration challenges for applications with custom networking stacks. These challenges include security risks associated with requiring high privileges and the complexity of integrating new hardware and operating system features.

### SUMMARY

The present disclosure addresses the foregoing challenges by providing systems and methods for leveraging underlying operating system networking stack in a user space networking stack with L7 functionality. The present disclosure is directed to establishing an abstraction layer (or shim layer) that serves as a bridge between a user space application and an operating system. The shim layer can translate events related to packet processing into equivalent packet types for easy integration with a user space stack. Thus, the present disclosure enables leveraging the operating system's networking abilities in packet processing without the need for a comprehensive redesign of the existing custom networking stack within a user space application.

In one aspect, the method can include establishing, by one or more processors, a shim layer as a network driver for a user space application implementing a user space portion of a network stack of a device. The shim layer can use an operating system portion of the network stack of the device to provide services at and below a transport layer. The method can include receiving, by the shim layer, an event from a kernel space portion of the network stack. The event can indicate that a transport layer connection with a remote device has been established by the portion of the network stack. The operating system portion of the network stack can perform a first transport layer connection handshake with the remote device to establish the transport layer connection. The method can include communicating, by the shim layer responsive to the event, a SYN packet, generated by the shim layer, to the user space application to initiate a second transport layer connection handshake with the user space application to establish the transport layer connection in the user space portion of the network stack. The method can include communicating, by the shim layer responsive to receiving a SYN ACK packet from the user space application, an ACK packet, generated by the shim layer, to complete the second transport layer connection handshake with the user space application. In some implementations, the user space application can include a custom stack at and above the transport layer.

The method can include receiving, by the shim layer, the event including a socket file descriptor for the transport layer connection established by the operating system portion of the network stack. The method can include the shim layer including the socket file descriptor in a source port of transport layer header in the SYN packet. In some implementations, the event can include an EPOLLIN event (e.g., an event from a control interface for an epoll file description of the Linux operating system) from the operating system portion of the network stack.

The method can include mapping, by the shim layer, tuple information for the transport layer connection established with the user space portion of the network stack via the second transport layer connection handshake. In some implementations, the tuple information for the transport layer connection established with the user space portion of the network stack can be different than tuple information for the transport layer connection established with the operating system portion of the network stack. The method can include identifying, by the shim layer, the socket file descriptor of the transport layer connection established with the operating system portion of the network stack from tuple information of a SYN-ACK packet from the user space application.

In another aspect, the method can include establishing, by one or more processors, a shim layer as a network driver for a user space application implementing a user space portion of a network stack of a device. The shim layer can use an operating system portion of the network stack of the device providing services at and below a transport layer. The method can include intercepting, by the shim layer, a SYN packet of a first transport layer connection handshake from the user space application to initiate a transport layer connection request with a remote device. The method can include communicating, by the shim layer, a connect call to the operating system portion of the network stack to initiate a second transport layer connection handshake with the remote device in the operating system portion of the network stack. The method can include receiving, by the shim layer, an event from the operating system portion of the network stack. The event can indicate that a transport layer connection with the remote device has been established by the operating system portion of the network stack via the second transport layer connection handshake. The operating system portion of the network stack can perform the second transport layer connection handshake with the remote device to establish the transport layer connection. The method can include communicating, by the shim layer responsive to the event, a SYN ACK packet, generated by the shim layer, to the user space application to establish as part of the first transport layer connection handshake the transport layer connection in the user space portion of the network stack.

The method can include receiving, by the shim layer, an ACK packet from the user space application to complete the first transport layer connection in the user space portion of the network stack. The method can include receiving, by the shim layer, the event comprising a socket file descriptor for the transport layer connection established by the operating system portion of the network stack via the second transport layer connection handshake. The method can include associating, by the shim layer, the socket file descriptor with tuple information of the SYN or ACK packet from the user space application. The method can include receiving, by the shim layer, a PSH-ACK packet of the transport layer connection having data to be communicated to the remote device via the transport layer connection established by the operating system portion of the network stack.

The method can include generating translated tuple information by translating, by the shim layer, tuple information of the PSH-ACK packet for the transport layer connection with the user space application to tuple information for the transport layer connection used by the operating system portion of the network stack with the remote device. The method can include using, by the shim layer based on the translated tuple information, a send call operating system portion of the network stack to send the data via the transport layer connection used by the operating system portion of the network stack with the remote device.

At least one aspect of the technical solutions is directed to a system. The system can include one or more processors coupled with memory. The one or more processors can be configured to install a shim layer as a network driver for a user space application implementing a user space portion of a network stack of a device. In some implementations, the shim layer can be configured to use an operating system portion of the network stack of the device providing services at and below a transport layer. In some implementations, the shim layer can be configured to perform a first transport layer connection handshake with the user space application to establish a transport layer connection with a remote device in the user space portion of the network stack. In some implementations, the shim layer can be configured to receive from the operating system portion of the network stack one or more events indicating the transport layer connection was established via a second transport layer connection handshake between the operating system portion of the network stack and the remote device. In some implementations, the shim layer can be configured to complete, responsive to receiving the one or more events, the first transport layer connection handshake with the user space application.

In some implementations, the shim layer can be configured to intercept, from the user space application, a SYN packet as part of the first transport layer connection handshake and initiate a connect call to the operating system portion of the network stack to initiate the second transport layer connection handshake. In some implementations, the shim layer can be configured to generate a SYN ACK packet and communicate the SYN ACK packet to the user space application to establish as part of the first transport layer connection handshake.

In some implementations, the shim layer can be configured to receive from the user space application a PSH-ACK packet of the transport layer connection having data to be communicated to the remote device via the transport layer connection established by the operating system portion of the network stack. In some implementations, the shim layer can be configured to translate tuple information of the PSH-ACK packet for the transport layer connection with the user space application to tuple information for the transport layer connection used by the operating system portion of the network stack with the remote device. In some implementations, the shim layer can be configured to send, based on the translated tuple information, the data via the transport layer connection used by the operating system portion of the network stack to the remote device. In some implementations, the user space application can include a custom stack at and above the transport layer. In some implementations, each of the operating system portion of the network stack and the user space application can have a transport layer.

### BRIEF DESCRIPTION OF THE DRAWINGS

The foregoing and other objects, aspects, features, and advantages of the disclosure will become more apparent and better understood by referring to the following description taken in conjunction with the accompanying drawings, in which:

FIG. 1A is a block diagram of a network computing system, in accordance with one or more implementations;

FIG. 1B is a block diagram of a network computing system for delivering a computing environment from a server to a client via an appliance, in accordance with one or more implementations;

FIG. 1C is a block diagram of a computing device, in accordance with one or more implementations;

FIG. 2 is a block diagram of an appliance for processing communications between a client and a server, in accordance with one or more implementations;

FIG. 3 is a block diagram of a virtualization environment, in accordance with one or more implementations;

FIG. 4 illustrates a block diagram of an example system for leveraging underlying operating system networking stack in a user space networking stack with application layer functionality, in accordance with one or more implementations;

FIG. 5A illustrates an example configuration of connection initiation by a user space application, in accordance with one or more implementations;

FIG. 5B illustrates an example configuration of connection establishment by a remote user, in accordance with one or more implementations;

FIG. 6A illustrates an example flow diagram of a method for establishing a connection initiated by a remote user, in accordance with one or more implementations;

FIG. 6B illustrates an example flow diagram of a method for establishing a connection initiated by a user space application, in accordance with one or more implementations;

FIG. 7A illustrates an example flow diagram of a method for managing incoming data on a socket file descriptor, in accordance with one or more implementations;

FIG. 7B illustrates an example flow diagram of a method for terminating a connection initiated by the remote end, in accordance with one or more implementations; and

FIG. 7C illustrates an example flow diagram of a method for terminating a connection initiated by a user space application, in accordance with one or more implementations.

### DETAILED DESCRIPTION

For purposes of reading the description of the various embodiments below, the following descriptions of the sections of the specification and their respective contents may be helpful:
Section A describes a network environment and computing environment which may be useful for practicing embodiments described herein.
Section B describes embodiments of systems and methods for delivering a computing environment to a remote user.
Section C describes embodiments of systems and methods for virtualizing an application delivery controller.
Section D describes embodiments of systems and methods of leveraging underlying operating system networking stack in a user space networking stack with application layer or layer 7 (L7) functionality.

### A. Network and Computing Environment

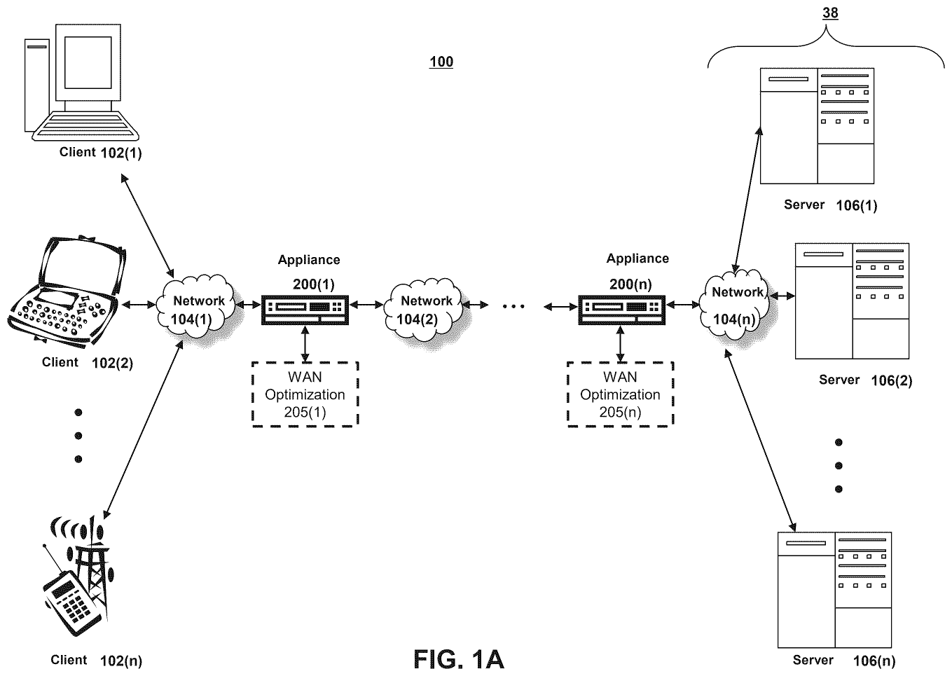

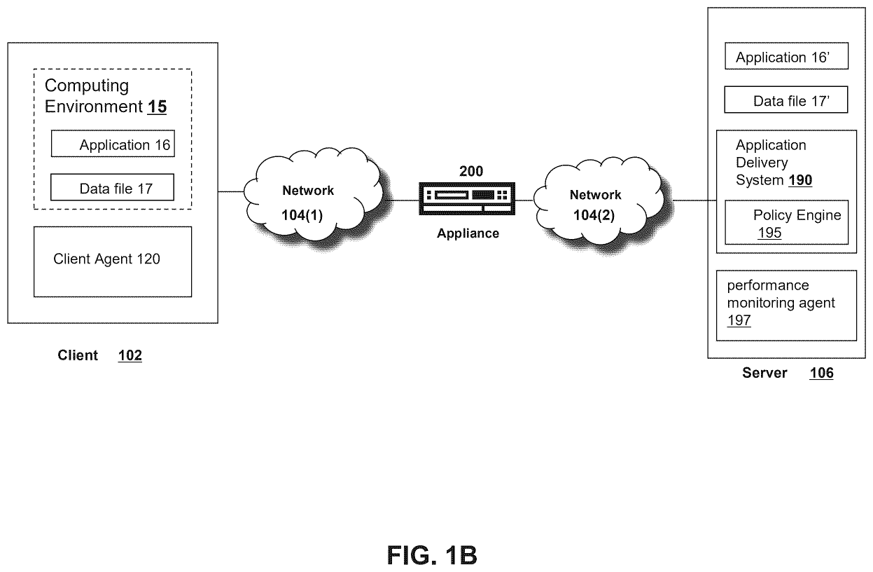

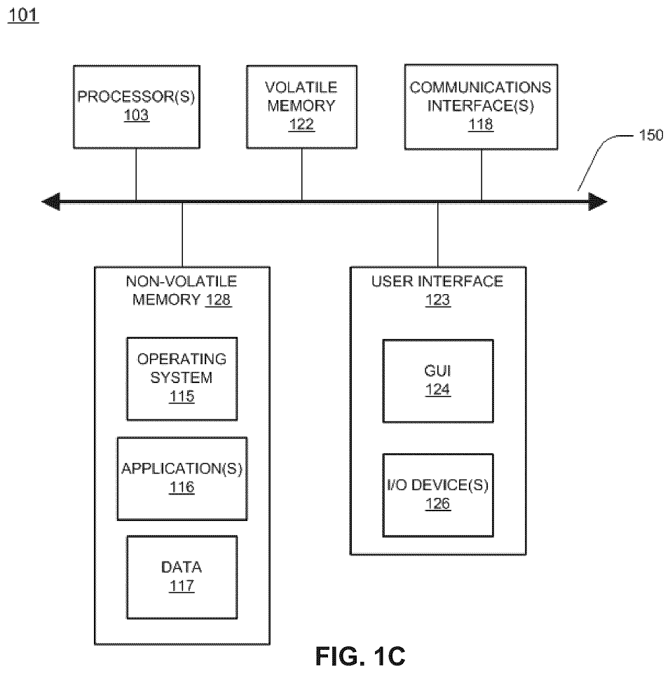

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as Citrix networking (formerly NetScaler®) products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as Citrix SD-WAN products sold by Citrix Systems, Inc. of Fort Lauderdale, FL.

Referring to FIG. 1B, an example network environment, 100′, for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application, 16, that accesses, processes or uses a data file 17. Computing environment 15, application 16 and/or data file 17 may be delivered via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment 15 to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as Citrix Virtual Apps and Desktops (formerly XenApp® and XenDesktop®).

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 120 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), desktop as a service (DaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliance 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as Citrix Analytics or Citrix Application Delivery Management by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

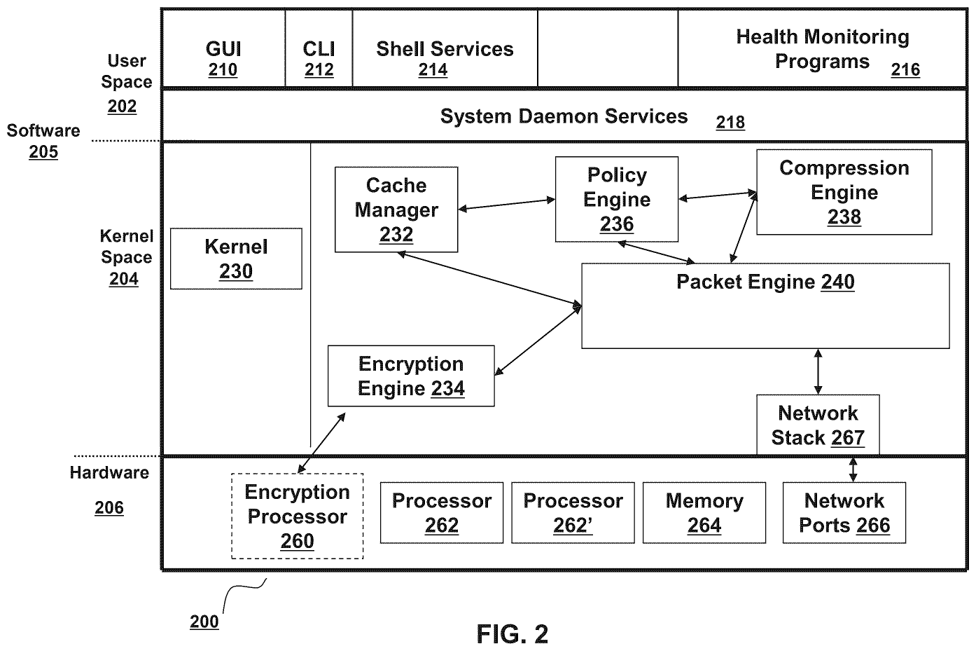

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application 104. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer 243 for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reducing the access time of the data. In some embodiments, the cache memory may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include the programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine if a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layer connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

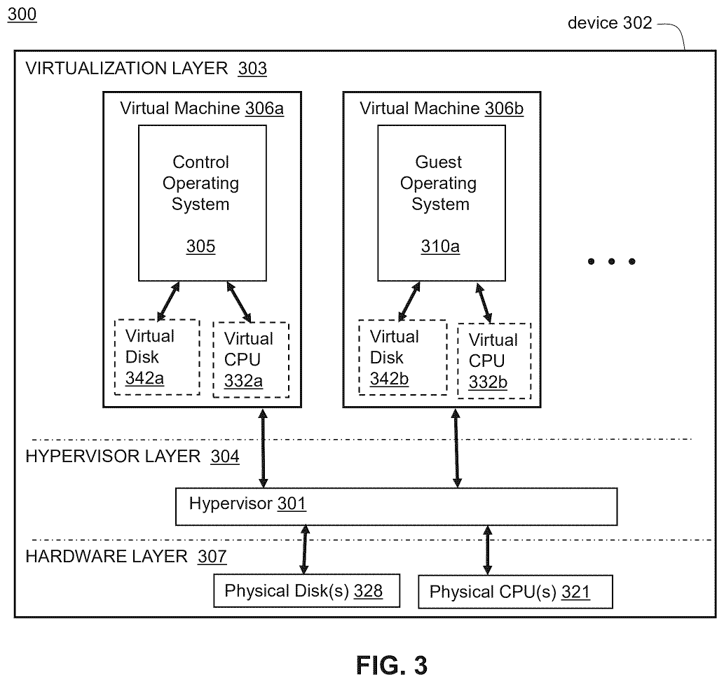

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a Citrix Hypervisor by Citrix Systems, Inc. of Fort Lauderdale, FL. In an illustrative embodiment, device 302 executing a hypervisor that creates a virtual machine platform on which guest operating systems may execute is referred to as a host server. 302

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. A plurality of appliances 200 or other computing devices (e.g., nodes) may be joined into a single cluster. A cluster may operate as an application server, network storage server, backup service, or any other type of computing device to perform many of the functions of appliances 200 and/or 205.

D. Systems and Methods for Leveraging Underlying Operating System Networking Stack in a User Space Networking Stack with Application Layer Functionality

Below are detailed descriptions of various concepts related to, and implementations of, techniques, approaches, methods, apparatuses, and systems for dynamically enabling and disabling aggregation control. The various concepts introduced above and discussed in greater detail below may be implemented in any of numerous ways, as the described concepts are not limited to any particular manner of implementation. Examples of specific implementations and applications are provided primarily for illustrative purposes.

The technical solutions of the present disclosure are directed to leveraging underlying operating system networking stack in a user space networking stack with layer 7 (L7) functionality (e.g., application layer). User space networking stacks with L7 functionality can present several technical challenges. For example, elevated privileges are required for direct packet processing at Layers 2 through 4, which not only introduces security risks but also restricts the ability to leverage newer features provided by the kernel. Additionally, supporting new hardware, particularly Network Interface Cards (NICs), requires the development of custom drivers for the user space application. The configuration can impact development timelines and ongoing maintenance efforts compared to leveraging existing kernel drivers. Moreover, bypassing the kernel networking stack restricts access to advanced functionalities available within the kernel. These functionalities may include advanced filtering, traffic shaping, or other features important for optimal network performance and security.

The technical solutions disclosed herein overcome these challenges by using a shim layer that functions as a bridge or interface between the user space application and the kernel networking stack. The shim layer can translate kernel events into TCP SYN packets for the user space application to process as new connection requests. The shim layer can extract information, such as source and destination ports, for connection management. For incoming data, the shim layer can read data arriving on a socket from the kernel, create a packet with relevant header details before sending it to the user space application. When the user-space application initiates a new connection by sending a SYN packet, the shim layer can intercept the packet. The shim layer can identify or extract the destination information (e.g., IP address and/or port) and use a system call to facilitate the connection with the kernel. The kernel returns a socket file descriptor (FD) that the shim layer can store to manage the connection. Upon successful establishment, the shim layer can create a SYN-ACK packet for the user space application. Furthermore, the shim layer can manage termination scenarios initiated by the user space application or the remote end. The shim layer can translate events and system calls between the user space application and the kernel to maintain session cleanup.

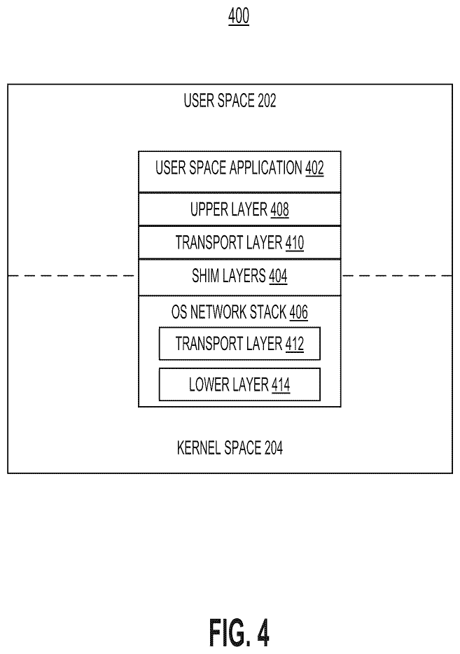

FIG. 4 illustrates an example system 400 for leveraging the underlying operating system networking stack in a user space networking stack with application layer or layer 7 functionality. Example system 400 can include a user space 202, a kernel space 204, and a shim layer 404 that can be communicatively coupled to the user space 204 and the kernel space 204. The specific mechanism for interaction between user space 202 and kernel space 204 can vary depending on the system architecture. The user space 202 can include one or more user space applications 402, one or more upper layers 408, and one or more portions of transport layers 410. One or more user space applications 402 can operate, execute, or run in user space 202 and interface via the user space portion of transport layer 410 with the shim layer 404. The kernel space 204 can include one or more operating system network stacks 406. The operating system network stacks 406 can include one or more transport layers 412 and one or more lower layers 414. The shim layer 404 can manage the interface and interactions of the user space 202 and user space application 402 with the kernel space 204 and operating system network stack 406.

User space 202 can refer to an environment or a portion of system memory where user-facing programs and applications can be executed, such as any embodiments of user space described in connection with FIG. 2. The user space 202 can provide a layer of abstraction between user-facing programs and the underlying hardware resources. In some implementations, the user space 202 can house various executable entities, including programs and applications that can perform specific tasks, such as web browsers, text editors, media players, and various utilities. In some implementations, the user space 202 can include processes and services that are running instances of programs, providing ongoing functionality in the background. In some implementations, the user space 202 can include tasks and scripts, which are smaller units of execution or functionalities within programs or services designed for specific automated functions. In some implementations, libraries and functions can reside in the user space 202, serving as reusable code components accessed by programs during execution to provide functionalities.

Kernel space 204, as described in connection with FIG. 2, can refer to a protected section of system memory reserved for the core operating system, commonly known as the kernel. The kernel space can facilitate privileged executions, allowing the processor to run kernel code with unrestricted access to system resources. The kernel space 204 can encompass OS functionalities for managing hardware, memory, processes, security, and network communication. To safeguard system stability and prevent malfunctions caused by user applications, kernel space 204 can be isolated and protected from user space. The kernel space 204 can house device drivers, which serve as interfaces to the system's hardware.

The user space applications 402 can be a software program, application, or set of programs or applications or other types and forms of executable instructions configured to carry out tasks or applications, such as to serve end-user requirements. The user space application 402 can operate or execute in a user space 202 of the operating system, such as at the application layer or layer 7 of the network stack. The user space applications 402 can include web browsing, email management, document creation and editing, multimedia playback, and interactive gaming, among other functionalities. Each user space application 402 can have its own memory space (e.g., user space) within the operating system, and may be allocated dedicated memory space of its own. The user space applications 402 can operate outside the kernel 204, which manages the core functionalities of the operating system. The user space applications 402 can execute their code within their memory space. The user space application 402 can implement custom or specific logic, functionality for its application and/or customer or specific portions of the network stack (e.g., custom network stack), such as via upper layers 408, transport layer 410, and shim layer 404.

The upper layer 408 of the network stack can be any portion of the network stack above the transport layer 410 or layer 4 of the network stack, such as layers 5 through 7 of the open systems interconnection (OSI) model. The upper layer 408 can include a program, application, process, service, task, script, library, function, or set of executable instructions. The upper layer 408 may include any functions, application programming interfaces (APIs), or executable instructions used by or within the user space application 402. The upper layers 408 can include, use, provide, or define their own protocols and data formats tailored to the desired needs of the user space application 402. For example, unlike the lower layers that focus on core network operations such as routing and data transmission, the upper layers 408 can provide a higher-level interface for the user space applications 402.

The transport layer 410 within user space 202 and used by the user space application 402 can provide transport layer services and functionality to the user space application 402. The transport layer 410 within user space 202 may implement any portion of the transport layer stack, such as using a protocol stack to provide end-to-end communication services for the user space application 402. Each protocol, such as transmission control protocol (TCP), user datagram protocol (UDP), and inter-process communication (IPC), can facilitate data transmission between applications on the same or different devices. In some embodiments, the transport layer 410 may include all of the functionality of the transport layer of the operating system network stack. In some embodiments, the transport layer 410 may include a portion of the functionality of the transport layer of the operating system network stack. In some embodiments, the transport layer 410 may include a customized version of the transport layer implementation. In some embodiments, the transport layer 410 may include a customized code or configuration to interface with the user space application 402, as if the transport layer 410 were the transport layer of the operating system network stack, while providing an interface to the shim layer 404 to interface with the kernel space and operating system network stack. In some implementations, the transport layer 410 can provide an application programming interface (API) that bridges the user space with the kernel space, such as via the shim layer 404. The API can include a set of methods for communication between various end points, including applications, software programs, processes, services, or tasks on such end points. In some implementations, the API can provide a set of methods, functions, or APIs for the user space applications 402 to interact with the transport layer functionalities.

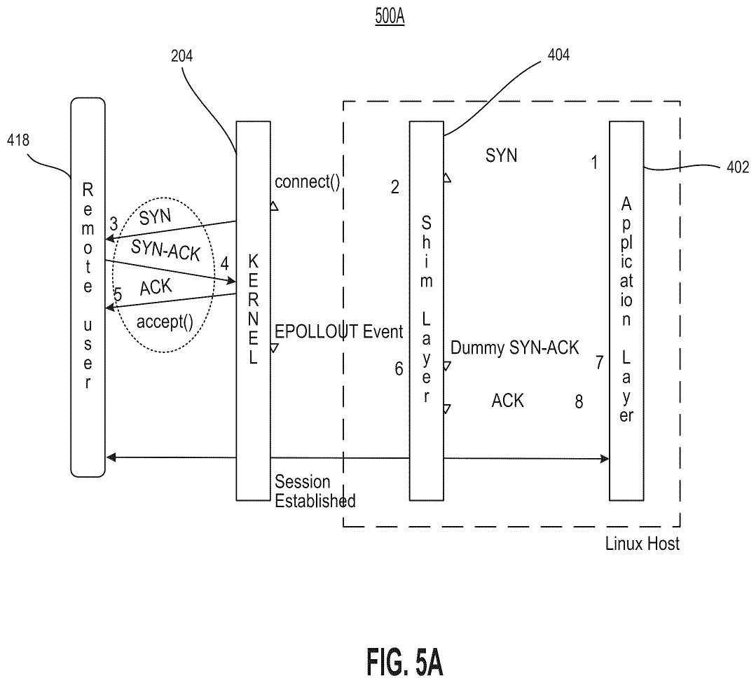

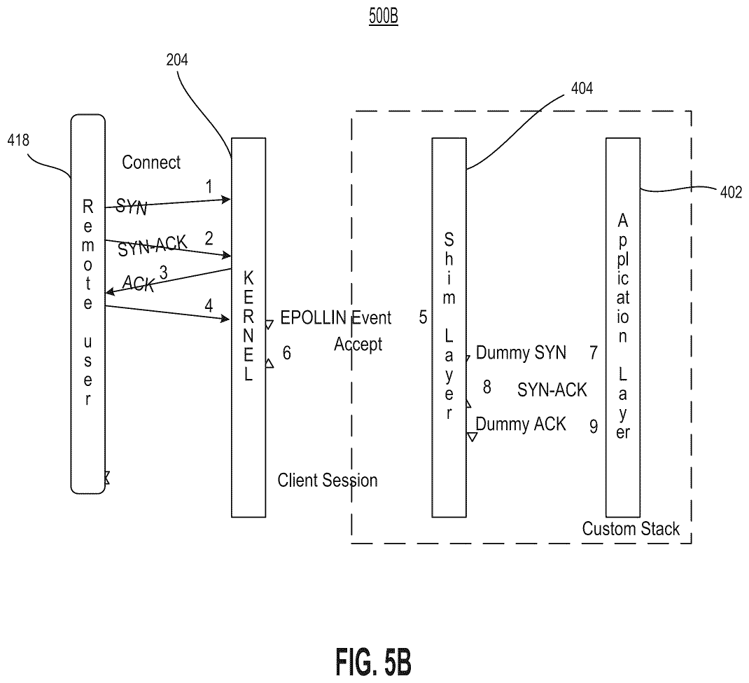

In some embodiments, the user space application 402 with the upper layer 408 and/or the transport layer 410 in the user space 202 and/or the shim layer 404 may be referred to as a custom network stack, such as depicted in FIGS. 5A and 5B. The systems and methods herein enable and allow the custom network stack to use the functions and features of the kernel space 204 and the operating system network stack through the shim layer 404 without changing the code or functionality of the user space application 402. For example, the transport layer 410 and shim layer 404 may be implemented to use the OS network stack 406 and kernel space 204 agnostically or transparently to the code and functionality of the user space application 402 without changing the code and functionality of the user space application 402 to do so.

The shim layer 404 can be a set of resources, APIs, methods, functions, code, or libraries that can function as an intermediary between the user space application 402 and the operating system network stack 406. The shim layer 404 may receive or intercept system calls made by user space applications 402 for network operations, such as by the user space application 402 making transport layer API or system calls. In some implementations, the shim layer 404 can be deployed in the user space portion of the network stack. In some implementations, the shim layer 404 can reside within the kernel space of the network stack. The shim layer 404, via its own protocols, can manage network operations independently for the user space application 402. In some implementations, the shim layer 404 can intercept network operations from the user space application 402 or the operating system network stack 406 and redirect the operations to a network interface. In some implementations, the shim layer 404 can use TCP/UDP sockets for network communication. In some implementations, the shim layer 404 can create TCP/UDP packets with the desired protocol headers, enabling a custom networking stack to function in user space 202 without relying directly on the operating system network stack 406. In some implementations, the shim layer 404 can interact with the operating system networking stack 406 through system calls. In some implementations, the shim layer 404 can interpret and convert system call data into relevant metadata and packets that the application portion of the stack (e.g., user space 202, user space application 402, transport layer 410, upper layer 408) can process.

The operating system (OS) network stack 406 can be a network protocol stack or communication stack that can enable communication over a network, such as a network stack provided by an operating system, for example, Linux. In some implementations, the operating system network stack 406 can be a set of networking protocols and software layers that work together to manage network communication. In some implementations, the operating system network stack 406 can facilitate processes such as data transfer, routing, addressing, and error handling among different network devices and interfaces. The operating system network stack 406 can include layers 1 through layer 4 of the OSI model, such as network stacks provided by an operating system, such as any version of Linux. The operating system network stack 406, or at least portions thereof, may operate in kernel space 204, such as any embodiments of the kernel space 204 described in connection with FIG. 2.

The transport layer 412 in or of the operating system network stack 406 can provide data transmission across a network, facilitate end-to-end communication, manage connections, and manage flow control, among other functionalities. The transport layer 412 can be any service, process, task, script, library, function, or any type and form of executable instructions. The transport layer 412 can include any functionality implemented by an operating system to provide layer 4 or transport layer services and functionality, such as in accordance with the OSI model of network stacks. The implementation(s) may be different based on the type and/or version of the operating system.

In some implementations, the operating system network stack 406 can perform its functions through the lower layer 414, which can be a service, process, task, script, library, function, or any type and form of executable instructions, such as drivers for network interfaces. The lower layer 414 can include several lower-level layers, including, but not limited to, the physical layer (L1), data link layer (L2), network layer (L3), and transport layer (L4). The physical layer can manage the physical transmission of data bits across network mediums such as cables or wireless connections. The data link layer can manage data packaging, addressing, and error detection within a network segment (e.g., ethernet). The network layer can facilitate routing and logical addressing for data packets across networks (e.g., via IP). The transport layer can maintain data transfer between applications on the same or different devices, supported by protocols such as TCP (transport control protocol) and UDP (user datagram protocol).

In some implementations, the layers of or within the lower layer 414 can be configured to work together in a cooperative and/or sequential manner. As the data packet travels through or down or up the operating system network stack 406 for communication, each layer can add its own header information. In some implementations, when the operating system network stack 406 is receiving data, each layer can process the header information relevant to its function before passing the data to the next layer. The headers can include information specific to the functionality of each layer. In some implementations, the headers can be added in a predefined order, with the header for the highest layer at the beginning and the header for the lowest layer closest to the data payload.

Referring now to FIG. 5A, depicted is an example configuration of connection initiation by a user space application. System 500A includes the user space application 402 running on a host (e.g., Linux host). The user space application 402 can use the interface to incorporate its own custom network stack configured for network communication, such as the transport layer 410 in communication with the shim layer 404. System 500A includes a shim layer 404 that functions as an intermediary between the user space application 402 and a kernel 204 (e.g., core or reserved memory space of the operating system) and the network stack 406 operating in the kernel space 204. The configuration of the system 500A enables the user application to take advantage of and use the functionality and features of the operating system network stack 406 in the kernel space 204 without changing its code and functionality to do so.

In an overview of FIG. 5A, the depicted configuration can include a series of acts (e.g., numbered 1 through 8). At Act 1, the user space application 402 sends a SYN packet to initiate a connection with a remote host. At Act 2, the shim layer 404 intercepts the SYN packet and uses the extracted or identified information to facilitate establishing a connection via the kernel 204 and its OS network stack. At Acts 3-5, the kernel 204 establishes a connection with the remote host. At Act 6, the kernel 204 triggers an EPOLLOUT event to notify the shim layer of the connection with the remote host. At Act 7, the shim layer 404 sends a SYN-ACK packet to the user space application 402. At Act 8, the user space application 402 responds with an ACK packet to the shim layer 404, completing the connection handshake.

In some implementations, the system 500A can install the shim layer 404 as a network driver for use by applications in the user space 202, such as the user space application 402. In some implementations, the shim layer 404 can be installed as a kernel driver or module. In some implementations, the shim layer 404 can be installed as a pre-loaded driver. The user space application 402 or the transport layer 410 of the user space 202 can be configured to use the shim layer 404. For example, during the initialization of the user space application 402, the user application 402 may load the shim layer interface to facilitate communication. The shim layer 404 can be implemented to be part of or have rights and privileges to access kernel space 204 and/or the operating system network stack operating 406 in kernel space 204. Some portions of the shim layer 404 may operate in kernel space 204, while other portions of the shim layer 404 may operate in user space 202. Although the interface between the user space 202 and the kernel space 204 is shown in FIG. 4 as occurring in or at the shim layer 404, portions of the operating system network stack 406 below the shim layer 404 may operate in the user space 202, such as portions of the transport layer, while portions of the transport layer and network stack above the shim layer 404 may operate in kernel space 204.

In some implementations, the system 500A can install, register or otherwise establish the shim layer 404 as a network driver with the operating system. During installation and/or registration with the operating system, the system 500A can use data structures, such as predefined data structures, that include fields for information about the shim layer 404. The system 500A can populate the data structures with details regarding the functionalities of shim layer 404, such as TCP and UDP socket management, data transfer, and flow control, among others. The system 500A can specify the network protocols the shim layer 404 can support, including TCP and UDP. The data structures can specify how the shim layer 404 interacts with resources, including memory allocation requests and network interface access calls. The user space application 402 can interact with the network through the standard transport layer APIs (e.g., such as APIs or functions using sockets) provided by the transport layer 410, 412 and network stack 406.

In some implementations, the shim layer 404 can interact with a custom networking stack of the user space application 402, such as a custom transport layer 410 and/or upper layer 408, or otherwise with code, functions, and APIs of the user space application 402. The shim layer 404 can provide functionalities such as connection establishment and management and perform packet processing for those connections to facilitate receiving and transmitting network packets over those connections. In some implementations, the shim layer 404 can translate the packets between the user space application's format and data structures and the format and data structures understood and used by the operating system's network stack or the kernel.

In some implementations, the shim layer 404 can be configured to facilitate a transport layer connection with the user space application 402, such as for a remote device, or application thereon, connecting to the device of the user space application 402 or for the user space application 402 to connect to the remote device, or application thereon. In some implementations, portions of the transport layer connection handshake can occur within a user space 202, while other portions of the transport layer connection handshake can occur within kernel space 204 The configuration can enable the user space application 402 to continue to use its connection establishment logic via its transport layer 410 and leverage the operating system network stack and the features, benefits, and functionality of the kernel space portions of the operating system network stack, including built in security and privileges.

At Act 1, as shown in FIG. 5A, the application layer 402 (e.g., the custom networking stack layer 4) can send a SYN packet to initiate a connection with a remote host (or a remote user 418). At Act 2, the SYN packet can be intercepted at the transmission (TX) path of the shim driver layer 404. For example, the shim layer 404 can intercept the SYN packet and identify or extract details, such as the source IP address, destination IP address, source port number, and destination port number, among others. The shim layer 404 can use the identified or extracted information to invoke the system call (e.g., connect ( ) to initiate connection establishment processes (e.g., a transport layer connection handshake) through the kernel 204.

In some implementations, the shim layer 404 can store tuple information returned from the system call. The tuple information can include information identified or extracted from the SYN packet (e.g., source/destination IP addresses and ports). The shim layer 404 can use tuple information for transport layer connections to identify, manage, map, and process transport layer connections between the user space 202 and user space application 402 and the kernel space 204 and operating system network stack 406. The shim layer 404 may use data structures and file descriptors to manage such transport layer connections of the operating system network stack 406 and the user application 402.

In some implementations, the shim layer 404 may implement, interface, use, or manage any type of control interface, file descriptors, event, polling, or other interface mechanisms of the operating system, such as in kernel space 204. For example, in the Linux operating system, the following interfaces are available to use by the shim layer: EPOLLIN, EPOLLPRI, EPOLLOUT, EPOLLRDNORM, EPOLLRDBAND, EPOLLWRNORM, EPOLLWRBAND, EPOLLMSG, EPOLLERR, EPOLLHUP, EPOLLRDHUP, EPOLLWAKEUP, EPOLLONESHOT, and EPOLLET, descriptions of which are described in any of the manual pages of the Linux implementation. In other operating systems and implementations, there may be different versions and implementations of control interface, events, and APIs for management of functionality, such as for file descriptors and events on the same, available in the kernel space 204 and/or operating system network stack 406.

In some implementations, the shim layer 404 can add a file descriptor (FD) to an epoll event list (e.g., events from a control interface for an epoll file description of the Linux operating system), which enables the shim layer 404 to wait for EPOLLOUT events (or any events indicating connection establishment) or EPOLLRDHUP/RDHUP events (or any events indicating connection termination) from kernel 204.

At Acts 3-5, the kernel 204 can process the connection establishment request using the information received from the shim layer 404. At Act 6, in the example of Linux, when the Linux kernel 204 successfully establishes a connection through the operating system networking stack, the kernel 204 can trigger an EPOLLOUT event, notifying the shim layer 404 of the availability of the socket FD for data exchange. In some implementations, the EPOLLOUT event can indicate that a transport layer connection with the remote device 418 has been established by the operating system portion of the network stack via the transport layer connection handshake. In some implementations, the EPOLLOUT event can be processed in the shim layer 404 as a confirmation for the SYN packet sent by the application layer 402 (custom layer 4).

At Act 7, in response to an EPOLLOUT event, the shim layer 404 can generate a SYN-ACK packet (e.g., a dummy SYN-ACK packet). The “dummy” SYN-ACK packet in this context can refer to a simulated or mock SYN-ACK network packet used within the system. For example, the dummy SYN-ACK packet can be an imitation of a real SYN-ACK packet to inform the user space application 402 that the connection setup process has progressed to a stage where the connection is ready to proceed. The dummy SYN-ACK packet can be used to facilitate the connection handshake with the user space application to mimic the SYN-ACK packet that occurred during the handshake by the kernel or operating system network stack for the transport layer connection managed by the kernel or operating system network stack. The dummy SYN-ACK packet can include flags (both SYN and ACK flags set), source and destination information (based on internal identifiers or information from or based on the kernel or operating system network stack transport layer connection, and sequence and acknowledgment numbers (placeholders or based on internal tracking or otherwise using or based sequence and acknowledgment numbers from the kernel or operating system network stack transport layer connection), among others. The shim layer 404 can communicate the SYN-ACK packet to the application layer 402 (custom networking stack) to establish the transport layer connection in the user space portion of the network stack.

At Act 8, upon receiving the SYN-ACK packet (confirmation from the shim layer), the application layer 402 (custom networking stack) can respond with an ACK packet to the shim layer 404. This response (ACK packet) can complete the connection establishment process (e.g., the transport layer connection in the user space portion of the network stack). The application layer 402 can then start maintaining a successful connection within its custom network stack.

In some implementations, upon receiving an EPOLLOUT event, which may include the socket FD, the shim layer 404 can associate the FD with the tuple information from the SYN or ACK packet received from the application layer 402. In some implementations, the shim layer 404 can receive a PSH-ACK packet that includes data intended for the remote device (or remote user 418) via the transport layer connection established by the operating system portion of the network stack. The PSH-ACK packet can include tuple information specific to the ongoing transport layer connection. The shim layer 404 can translate the tuple information of the PSH-ACK packet for compatibility with the transport layer connection used by the operating system portion of the network stack. Based on the translated tuple information, the shim layer 404 can use a send call to the operating system portion of the network stack to send the data via the transport layer connection used by the operating system portion with the remote device 418.

Referring now to FIG. 5B, depicted is an example configuration of connection establishment by a remote device or user. In an overview of FIG. 5B, the depicted configuration can include a series of acts (e.g., numbered 1 through 9). At Acts 1-3, the remote user 418 connects with the kernel 204. At Act 4, the kernel 204 receives a connection request and triggers an EPOLLIN event indicating a new connection. At Act 5, the kernel 204 accepts the connection request and assigns a file descriptor (FD). At Act 6, the kernel 204 sends an EPOLLIN event that may include the socket FD for the established connection. At Act 7, the shim layer 404 translates the event into a SYN packet (e.g., dummy SYN packet) for the user space application 402. At Act 8, the user space application 402 generates a SYN-ACK packet in response to the received SYN packet. At Act 9, the shim layer generates a dummy ACK packet and places or injects the dummy ACK packet into the receiving path to complete the transport layer connection handshake with the user space application 402.

Acts 1-3, as shown in FIG. 5B, include the remote user 418 connecting to the kernel 204. At Act 4, when a new client (or a remote user 418) attempts to connect to a Linux listening socket, the kernel 204 can receive the connection request and trigger an EPOLLIN event. The EPOLLIN event can indicate the presence of data to be read on the listening socket (e.g., indicating that a transport layer connection with a remote device has been established by the portion of the network stack).

At Act 5, after accepting the connection request (e.g., via the accept ( ) system call), the kernel 204 can assign a file descriptor (FD) for identification. For example, in some implementations, the EPOLLIN event can include the socket file descriptor (FD) for the transport layer connection established by the operating system portion of the network stack. At Act 6, the kernel 204 can send the EPOLLIN event that may include the socket FD for the established connection.

At Act 7, the shim layer 404 can translate the EPOLLIN event into a SYN packet (e.g., a dummy SYN packet) for processing by the application layer 402 to facilitate a transport layer connection handshake with the user space application 402. The “dummy” SYN packet in this context can refer to a simulated or mock SYN packet and can function as an internal notification mechanism within the system. The dummy SYN packet can function as a signal sent by the shim layer 404 to the user space application 402 to indicate that the connection setup process has progressed to a stage where the user space application 402 may have to take further actions to complete the handshake. The dummy SYN packet can be used to facilitate the connection handshake with the user space application to mimic the SYN packet that occurred during the handshake by the kernel or operating system network stack for the transport layer connection managed by the kernel or operating system network stack In some implementations. The dummy SYN packet can include flags (SYN flag set), source and destination information (based on internal identifiers or information from or based on the kernel or operating system network stack transport layer connection, and sequence and acknowledgment numbers (placeholders or based on internal tracking or otherwise using or based sequence and acknowledgment numbers from the kernel or operating system network stack transport layer connection), among others. The specific content and format of the dummy SYN packet may vary depending on the system implementation. The SYN packet can include the socket FD in a source port of the transport layer header.

At Act 8, the application layer 402 can generate a SYN-ACK packet in response to the received SYN packet. The SYN-ACK packet can include the received source port from the SYN packet as the destination port and a randomly chosen port for the application on the source side. In some implementations, the shim layer 404 can process the SYN-ACK packet in the transmission (TX) path. The shim layer 404 can retrieve the FD associated with the connection using the destination port of the TCP header to identify the client connection. In some implementations, the shim layer 404 can retrieve the tuple information, including, IP address of the application, port of the application, IP address of the client, and port of the client, among others, to identify the specific client connection, The FD or tuple details can be added to the epoll event for further communication handling. For example, the shim layer 404 can use the identified or extracted tuple information to manage the connection and associate the connection with an identifier within a database.

In some implementations, the shim layer 404 can map the tuple information for the transport layer connection established with the user space portion of the network stack via the transport layer connection handshake. The tuple information for the transport layer connection with the user space portion of the network stack can be different from the tuple information for the transport layer connection with the operating system portion of the network stack.

At Act 9, during SYN-ACK handling at the shim layer 404, an ACK packet (e.g., a dummy ACK packet) can be generated. The “dummy” ACK packet in this context can refer to a simulated or mock ACK packet and can function as an internal acknowledgment indicator within the network stack. The dummy ACK packet can be used to facilitate the connection handshake with the user space application to mimic the ACK packet that occurred during the handshake by the kernel or operating system network stack for the transport layer connection managed by the kernel or operating system network stack. The dummy ACK packet can include flags (ACK flag set source and destination information (based on internal identifiers or information from or based on the kernel or operating system network stack transport layer connection, and sequence and acknowledgment numbers (placeholders or based on internal tracking or otherwise using or based sequence and acknowledgment numbers from the kernel or operating system network stack transport layer connection), among others. The shim layer can place or inject the ACK packet into the receiving (RX) path such that the ACK packet can reach layer 4 of the custom networking stack to complete the transport layer connection handshake, and a session can be established with the user space application 402. In some implementations, the sequence number, acknowledgment number, and other TCP header fields can be filled in the generated ACK packet based on the stored information, such as the FD or connection tuple details.

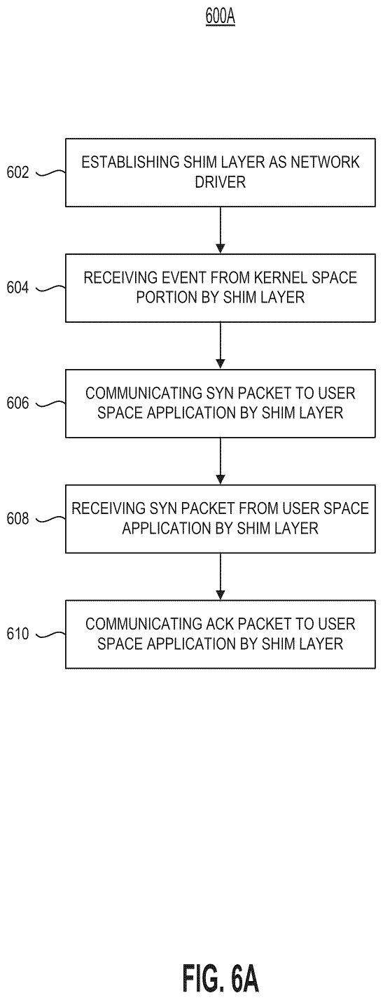

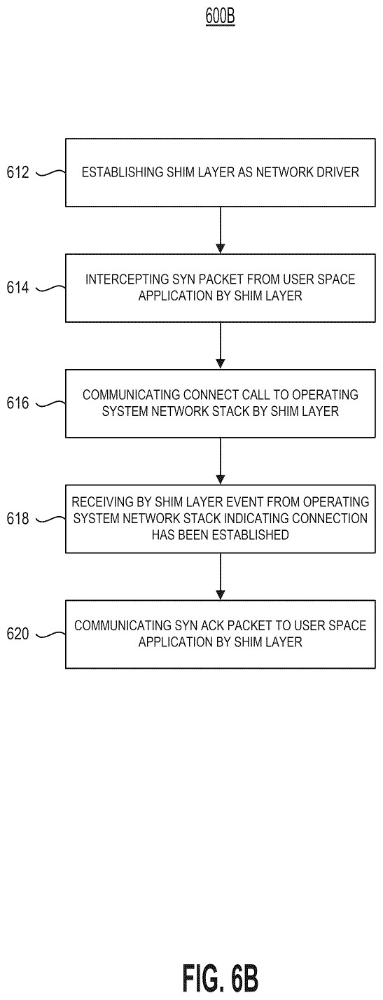

Referring now to FIG. 6A, depicted is an example flow diagram of a method for establishing a connection initiated by a remote user. The method 600A can be implemented using any other features discussed in FIGS. 1-5. The method 600A can include acts 602 through 610. At 602, the one or more processors can be configured to establish a shim layer as a network driver for a user space application. At 604, the shim layer can receive an event from kernel space portion of the network stack. At 606, the shim layer can communicate a SYN packet to the user space application. At 608, the shim layer can receive a SYN ACK packet from the user space application. At 610, the shim layer can communicate an ACK packet to the user space application.

At 602, the one or more processors can be configured to establish a shim layer as a network driver for a user space application. The shim layer may be installed, registered or otherwise established as part of the network stack. The shim layer may be installed to appear as a network driver or as a network interface accessible and useable by a user space application, such as for transport layer services. The shim layer can use the operating system portion of the network stack to provide services at and below the transport layer.

At 604, the shim layer can receive an event from kernel space portion of the network stack. In some implementations, the event can include an EPOLLIN event from the operating system portion of the network stack. The event can indicate that a transport layer connection with a remote device has been established by the portion of the network stack. In some implementations, the event can indicate that the operating system portion of the network stack has performed a transport layer connection handshake with the remote device to establish the transport layer connection. In some implementations, the event can include a socket file descriptor for the transport layer connection established by the operating system portion of the network stack. In some implementations, the shim layer can include the socket file descriptor in a source port of transport layer header in the SYN packet.

In some implementations, the shim layer can map tuple information for the transport layer connection established with the user space portion of the network stack via the transport layer connection handshake. In some implementations, the tuple information for the transport layer connection established with the user space portion of the network stack can vary. For example, in some implementations, the tuple information for the transport layer connection established with the user space portion of the network stack can be different from the tuple information for the transport layer connection established with the operating system portion of the network stack.

At 606, the shim layer can communicate a SYN packet to the user space application. In some implementations, the shim layer can generate the SYN packet. In some implementations, the shim layer can generate the SYN packet in response to receiving the event. In some implementations, the shim layer can communicate the SYN packet to facilitate a transport layer connection handshake with the user space application. In some implementations, the shim layer can facilitate the transport layer connection handshake with the user space application to establish the transport layer connection in the user space portion of the network stack.

At 608, the shim layer can receive a SYN-ACK packet from the user space application. The SYN ACK packet can indicate the completion of the transport layer connection handshake with the user space application. In some implementations, the shim layer can identify the socket file descriptor. The socket file descriptor can be for the transport layer connection established with the operating system portion of the network stack. In some implementations, the shim layer can identify the socket file descriptor from the tuple information of the SYN-ACK packet received from the user space application.

At 610, the shim layer can communicate an ACK packet to the user space application. The shim layer can generate the ACK packet. In some implementations, the shim layer can communicate the ACK packet to the user space application in response to receiving the SYN-ACK packet from the user space application. In some implementations, the shim layer can communicate the ACK packet to complete the transport layer connection handshake with the user space application.

Referring now to FIG. 6B, depicted is an example flow diagram of a method for establishing a connection initiated by a user space application. The method 600B can be implemented using any other functions, operations or features discussed in FIGS. 1-5. The method 600B can include acts 612 through 620. At 612, the one or more processors can be configured to establish a shim layer as a network driver for a user space application. At 614, the shim layer can intercept a SYN packet from the user space application. At 616, the shim layer can communicate a connect call to the operating system portion of the network stack. At 618, the shim layer can receive an event from the operating system portion of the network stack. At 620, the shim layer can communicate a SYN ACK packet to the user space application in response to receiving the event.

At 612, the one or more processors can be configured to establish a shim layer as a network driver for a user space application. The user space application can use a user space portion of a network stack. The shim layer can use an operating system portion of the network stack. The shim layer can use the operating system portion of the network stack to provide services at and below a transport layer.

In network communication models, such as the OSI model, “below the transport layer” can refer to any of the three layers (L1-L3) (e.g., physical layer, data link layer, and network layer), which are below the transport layer (LA). Any function or operation being performed or implemented below the transport layer can be performed or implemented at any of layer 1, layer 2, or layer 3, across two or more layers of layer 1 through 3, such as layer 2 and layer 3, or across all three layers of layer 1 through 3. The lower layers provide the functionalities that establish network connections and prepare data for transfer across networks. The lower layers can operate closer to the hardware and lay the groundwork for the transport layer (L4) to manage application-level communication. For example, layer 1 (the physical layer) deals with the physical transmission of raw data bits over a communication medium (e.g., cables, wireless systems). Layer 2 (the data link layer) manages data transmission between network devices (or nodes) on the same physical link (e.g., devices on an Ethernet network). Layer 3 (e.g., the network layer) provides routing and addressing functionalities that move data packets across networks to their destinations (e.g., using IP addresses).

At 614, the shim layer can intercept a SYN packet from the user space application. The SYN packet can indicate the initiation of the transport layer connection handshake. Upon intercepting the SYN packet, the shim layer can facilitate a transport layer connection request with a remote device.

At 616, the shim layer can communicate a connect call to the operating system portion of the network stack. In some implementations, the connect call can initiate a transport layer connection handshake with the remote device in the operating system portion of the network stack. In some implementations, the remote device can be managed through the operating system portion of the network stack.

At 618, the shim layer can receive an event (e.g., EPOLLOUT event) from the operating system portion of the network stack. In some implementations, the event can indicate that a transport layer connection with the remote device has been established. In some implementations, the transport layer connection with the remote device can be established via the transport layer connection handshake. In some implementations, the operating system portion of the network stack can perform the transport layer connection handshake with the remote device. In some implementations, the transport layer connection handshake can establish the transport layer connection.

In some implementations, the operating system portion of the network stack can establish the transport layer connection via the transport layer connection handshake. In some implementations, the event can include a socket file descriptor for the transport layer connection. In some implementations, the shim layer can associate the socket file descriptor with tuple information of the SYN or ACK packet from the user space application. In some implementations, the shim layer can receive a PSH-ACK packet from the transport layer connection. In some implementations, the PSH-ACK packet can include data to be communicated to the remote device via the transport layer connection.

In some implementations, the shim layer can translate the tuple information of the PSH-ACK packet. The PSH-ACK packet can be linked to the transport layer connection associated with the user space application. The shim layer can translate the tuple information for use by the operating system portion of the network stack. In some implementations, the translated information can facilitate communication with the remote device. In some implementations, based on the translated tuple information, the shim layer can use a send call operating system portion of the network stack to send the data via the transport layer connection used by the operating system portion of the network stack with the remote device.

At 620, the shim layer can communicate a SYN ACK packet to the user space application in response to receiving the event. In some implementations, the shim layer can generate the SYN ACK packet. In some implementations, the shim layer can communicate the SYN ACK packet to establish the transport layer connection in the user space portion of the network stack as part of the transport layer connection handshake. In some implementations, the shim layer can receive an ACK packet from the user space application to indicate the completion of the first transport layer connection in the user space portion of the network stack.

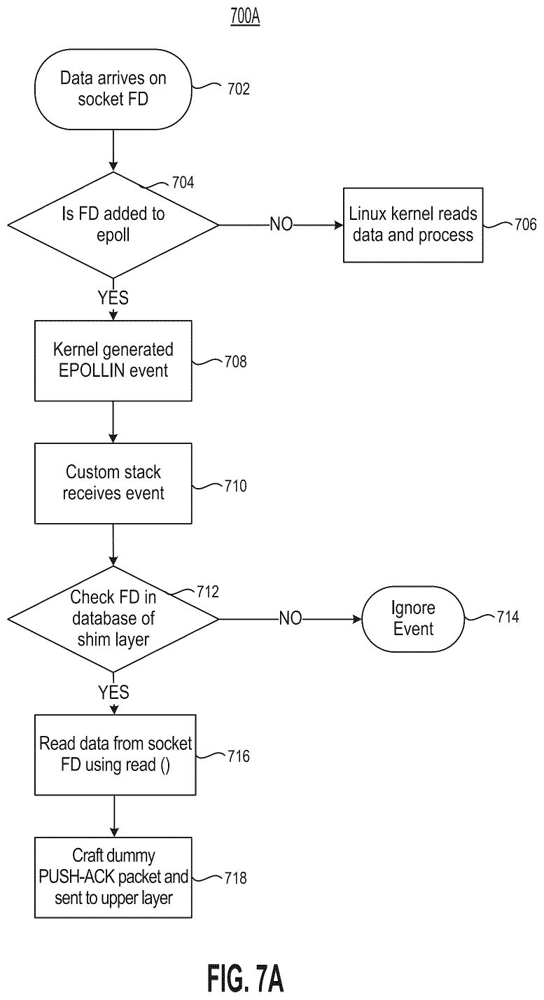

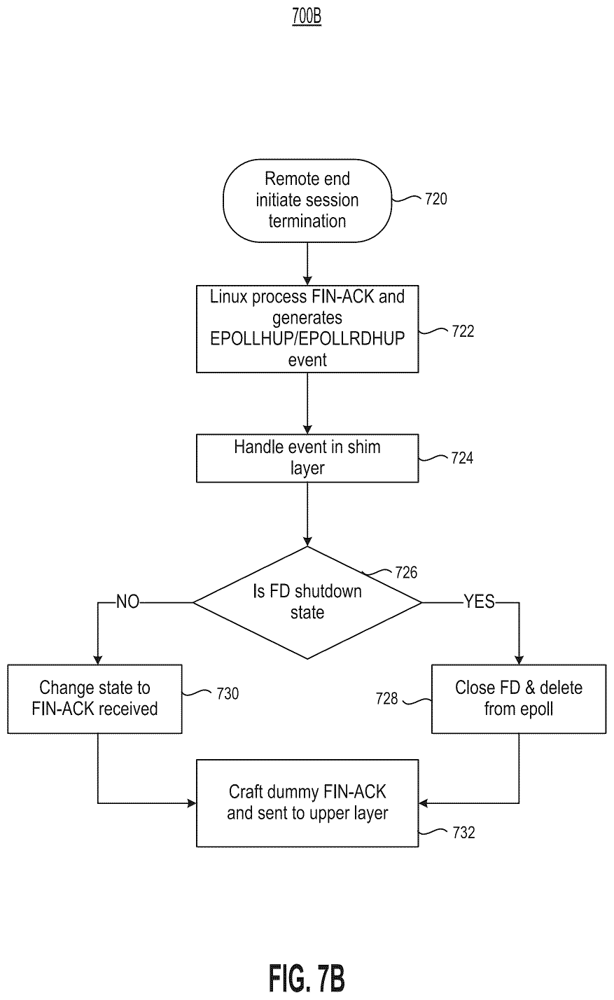

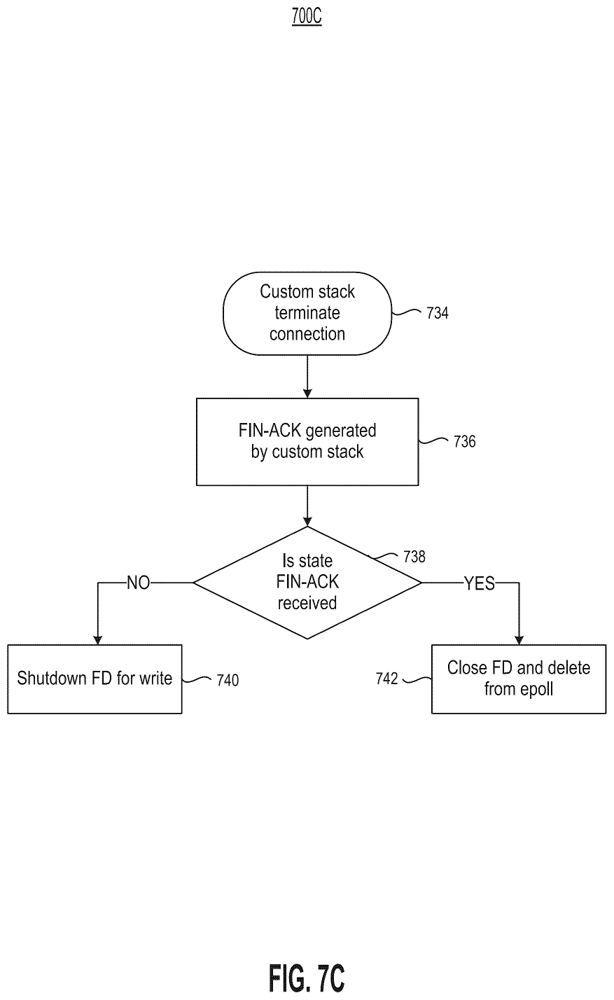

Referring now to FIG. 7A, depicted is an example flow diagram of a method for managing incoming data on a socket file descriptor in a system with a custom network stack, the shim layer, and the operating system network stack. For example, when data arrives on a specific socket, the data can be identified by its file descriptor (FD) (Act 702). The kernel (or the OS network stack) can validate whether the FD is already registered with epoll (Act 704). In some implementations, epoll can be a monitoring mechanism in the kernel that monitors events on multiple file descriptors. In some implementations, if the FD is not registered with epoll, the kernel can read and process the incoming data on the socket (Act 706). In some implementations, if the FD is registered with epoll, the kernel can generate an EPOLLIN event to notify the custom stack (e.g., user space application) about data availability or arrival on the socket (Act 708).

In some implementations, the custom network stack (such as via shim layer and transport layer) can receive the EPOLLIN event notification from the kernel (e.g., in the receiving path (RX)) (Act 710). Upon receiving the EPOLLIN event, the shim layer can read the data from the socket FD. The shim layer can create or generate a PUSH-ACK packet. The PUSH-ACK packet can include the L4 header details. In some implementations, the L4 header details may come from information previously stored in the shim layer. In some implementations, the shim layer can add dummy headers as placeholders or simulated headers for internal communication within the system. In some implementations, the shim layer can embed the read data from the socket FD into the PUSH-ACK packet.

In some implementations, the shim layer can check a connection database (e.g., maintained by the shim layer) to determine whether the FD is associated with an existing transport layer connection of the user space application (Act 712). For example, upon receiving an EPOLLIN event (indicating data on a socket), the shim layer can query the database using the FD to determine if the FD is associated with a known custom stack connection. If the FD is not found in the connection database of the shim layer (e.g., not associated with a known connection), this will imply that the event is not associated with any known custom stack connection, and the shim layer may ignore the event (Act 714). In some implementations, if the FD is found in the database (e.g., associated with a custom stack connection), the shim layer can read the data from the socket using a system call (e.g., via read ( ) (Act 716). In some implementations, the shim layer can generate or use a dummy PUSH-ACK packet. The “dummy” PUSH-ACK packet in this context can refer to a simulated packet for internal communication between the shim layer and the user space application. For example, in this regard, the dummy PUSH-ACK packet can be used to indicate that data has been received and signal processing of the received data by the receiver.

In some implementations, the shim layer can send the dummy PUSH-ACK packet to the user space application (e.g., layer 7) (Act 718). In some implementations, when the user space application (e.g., layer 7) transmits a reply with some data in a PUSH-ACK packet, the shim layer's handling can remain the same. For example, the same handling can apply when the user space application transmits new data to another connection through PUSH-ACK. In some implementations, at the transmission path (e.g., TX) of the shim layer, the PUSH-ACK packet can be intercepted. For example, the shim layer can identify or retrieve the corresponding socket FD from the stored details. In some implementations, the shim layer can write the data from the PUSH-ACK packet into the socket using the sendto( ) system call. After this, the Linux kernel can take care of sending the data on the network through the network interface or socket. Upon a successful sendto( ) call (e.g., indicating data delivery to the kernel), the shim layer can generate a dummy ACK for internal communication. The dummy ACK can have accurate sequence and acknowledgment numbers based on the information maintained by the OS network stack for the transport layer connection. The shim layer can send the dummy ACK to the receiving path (RX) of the user space application.

Referring now to FIG. 7B, depicted is an example flow diagram of a method for terminating a connection initiated by a remote end. In some implementations, the remote end can initiate session termination (Act 720). In some implementations, the remote end can initiate session termination due to an error. The remote end can send a RESET/FIN-ACK packet to the kernel (or the OS network stack), indicating termination and/or error conditions. In some implementations, the remote end can initiate session termination upon completion of the session. The remote end can send a FIN-PUSH-ACK packet, indicating the end of the session along with the data transmission.

In some implementations, the kernel (e.g., Linux kernel) can receive the termination packet (RESET/FIN-ACK or FIN-PUSH-ACK) from the remote end. The kernel can process the termination packet. The kernel can generate an EPOLLHUP/EPOLLRDHUP event for the associated socket file descriptor (Act 722). In some implementations, the system can manage the EPOLLHUP/EPOLLRDHUP event in a shim layer (Act 724). The shim layer can maintain a database that maps relevant data to each socket file descriptor (FD).

In some implementations, the shim layer can intercept the EPOLLHUP/EPOLLRDHUP event. The shim layer can validate whether the socket identified by the FD is already in a shutdown state (Act 726). If the socket is already in a shutdown state, the shim layer can close the FD (e.g., via close (fd) system call). In some implementations, the shim layer can remove the FD from the epoll registration (Act 728). In some implementations, if the socket is not in a shutdown state, the shim layer 404 can change the internal state of the connection to indicate receiving a FIN-ACK (e.g., acknowledgment of termination) (Act 730).

In some implementations, the termination packet can be a FIN-ACK packet (e.g., with no data). The shim layer can treat the packet as a FIN-PUSH-ACK packet. The shim layer can generate or use a dummy FIN-ACK packet. The “dummy” FIN-ACK in this context can refer to a simulated packet generated or used by the shim layer. The dummy FIN-ACK can indicate the intention to terminate the connection and can include an acknowledgement of the receipt of data from the remote end. The shim layer can send the dummy FIN-ACK packet to the custom stack (e.g., the user space application) (Act 732). In some implementations, the socket can remain open in the kernel and the custom stack layer (e.g., the user space application). In some implementations, the custom stack (via the user space application or the transport layer) can respond with a FIN-ACK or FIN-PUSH-ACK packet. Upon receiving the response from the custom stack (e.g., the user space application), the shim layer can call close (fd) to indicate to the kernel that it is closing the socket,

In some implementations, the termination packet can include data. The shim layer can create or use a dummy FIN-ACK packet. The shim layer can send the dummy FIN-ACK packet to the custom stack (e.g., the user space application). In some implementations, the socket remains open until the custom stack (e.g., the user space application) responds. In some implementations, the custom stack (e.g., the user space application) can respond with the FIN-ACK or FIN-PUSH-ACK packet. The shim layer can call close (fd) to indicate to the kernel that it is closing the socket.

Referring now to FIG. 7C, depicted is an example flow diagram of a method for terminating a connection initiated by a user space application. The custom stack (such as via the user space application and transport layer) can initiate the process of terminating or closing the connection (Act 734). The custom stack (e.g., via the user space application) can generate a FIN-ACK or FIN-PUSH-ACK packet (Act 736) and send the FIN-ACK or FIN-PUSH-ACK packet to the remote end. In some implementations, the FIN-ACK or FIN-PUSH-ACK packet can indicate the end of data transmission to the remote device. In some implementations, the FIN-ACK packet can indicate that the application has completed the data transmission. In some implementations, the FIN-PUSH-ACK packet can include any remaining data along with the termination request.

In some implementations, the shim layer can intercept the FIN-ACK/FIN-PUSH-ACK. In some implementations, upon receiving a notification (e.g., regarding the FIN-ACK/FIN-PUSH-ACK packet), the shim layer can determine the state of the FIN-ACK reception (Act 738). If the FIN-ACK packet is not received, the shim layer can execute the shutdown ( ) system call to shut down the write end of the socket FD (Act 740). In some implementations, if the FIN-ACK packet is received, indicating the completion of the session from the remote end, the shim layer can proceed to close the socket FD and remove the session from the epoll registration (Act 742). The socket FD can remain open to receive any incoming data from the remote end. In some implementations, the kernel can register the termination notification.

In some implementations, the kernel can generate an EPOLLHUP/EPOLLRDHUP event to indicate the termination request of the remote end. The shim layer can intercept the EPOLLHUP/EPOLLRDHUP event. Upon intercepting the EPOLLHUP/EPOLLRDHUP event, the shim layer can call the close (fd) system call to fully close the socket, terminating the session in the application and the kernel. In some implementations, upon receiving the FIN-ACK packet, the shim layer can call the close (fd) system call to close the socket FD.

In some implementations, the custom stack (e.g., via the user space application or the transport layer) can initiate immediate termination by sending a RESET or RESET-ACK packet to the remote end. The shim layer can directly intercept the RESET/RESET-ACK packet. In some implementations, upon receiving the direct termination request, the shim layer can execute the close (fd) system call to abruptly terminate the connection in the custom stack (the user space application) and the kernel (or the OS network stack). In some implementations, the close (fd) system call can bring down the established connection in the user space application and the OS network stack.

While the disclosure has been described with respect to specific embodiments, one skilled in the art will recognize that numerous modifications are possible. For instance, although specific examples of rules (including triggering conditions and/or resulting actions) and processes for generating suggested rules are described, other rules and processes can be implemented. Embodiments of the disclosure can be realized using a variety of computer systems and communication technologies including but not limited to specific examples described herein.

Embodiments of the present disclosure can be realized using any combination of dedicated components and/or programmable processors and/or other programmable devices. The various processes described herein can be implemented on the same processor or different processors in any combination. Where components are described as being configured to perform certain operations, such configuration can be accomplished, e.g., by designing electronic circuits to perform the operation, by programming programmable electronic circuits (such as microprocessors) to perform the operation, or any combination thereof. Further, while the embodiments described above may make reference to specific hardware and software components, those skilled in the art will appreciate that different combinations of hardware and/or software components may also be used and that particular operations described as being implemented in hardware might also be implemented in software or vice versa.

Computer programs incorporating various features of the present disclosure may be encoded and stored on various computer readable storage media; suitable media include magnetic disk or tape, optical storage media such as compact disk (CD) or DVD (digital versatile disk), flash memory, and other non-transitory media. Computer readable media encoded with the program code may be packaged with a compatible electronic device, or the program code may be provided separately from electronic devices (e.g., via Internet download or as a separately packaged computer-readable storage medium).

Thus, although the disclosure has been described with respect to specific embodiments, it will be appreciated that the disclosure is intended to cover all modifications and equivalents within the scope of the following claims.

The machine learning model may be periodically and/or continuously trained. For instance, as the recommendations (or other predictions and derived information) are presented to the end-user, the system may monitor the end-user's behavior (e.g., whether a recommendation was accepted/rejected or whether a predicted attribute was revised). The monitored data may be fed back into the machine learning model to improve its accuracy. The machine learning model can re-calibrate itself accordingly, such that the results are customized for the end-user.

It should be understood that the disclosed embodiments are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. Thus, it is to be understood that other embodiments can be utilized and functional, logical, operational, organizational, structural and/or topological modifications may be made without departing from the scope of the disclosure. As such, all examples and/or embodiments are deemed to be non-limiting throughout this disclosure.

Some embodiments described herein relate to methods. It should be understood that such methods can be computer implemented methods (e.g., instructions stored in memory and executed on processors). Where methods described above indicate certain events occurring in a certain order, the ordering of certain events can be modified. Additionally, certain of the events can be performed repeatedly, concurrently in a parallel process when possible, as well as performed sequentially as described above. Furthermore, certain embodiments can omit one or more described events.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a general-purpose processor, a field-programmable gate array (FPGA), and/or an application-specific integrated circuit (ASIC). Software modules (executed on hardware) can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments can be implemented using Python, Java, JavaScript, C++, and/or other programming languages and software development tools. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The drawings primarily are for illustrative purposes and are not intended to limit the scope of the subject matter described herein. The drawings are not necessarily to scale; in some instances, various aspects of the subject matter disclosed herein can be shown exaggerated or enlarged in the drawings to facilitate an understanding of different features. In the drawings, like reference characters generally refer to like features (e.g., functionally similar and/or structurally similar elements).

The acts performed as part of a disclosed method(s) can be ordered in any suitable way. Accordingly, embodiments can be constructed in which processes or steps are executed in an order different than illustrated, which can include performing some steps or processes simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements can optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements can optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A method comprising:
establishing, by one or more processors, a shim layer as a network driver for a user space application implementing a user space portion of a network stack of a device the shim layer using an operating system portion of the network stack of the device providing services at and below a transport layer;
receiving, by the shim layer, an event from a kernel space portion of the network stack, the event indicating a transport layer connection with a remote device has been established by the portion of the network stack, the operating system portion of the network stack having performed a first transport layer connection handshake with the remote device to establish the transport layer connection;
communicating, by the shim layer responsive to the event, a SYN packet, generated by the shim layer, to the user space application to initiate a second transport layer connection handshake with the user space application to establish the transport layer connection in the user space portion of the network stack; and
communicating, by the shim layer responsive to receiving a SYN ACK packet from the user space application, an ACK packet, generated by the shim layer, to complete the second transport layer connection handshake with the user space application.

2. The method of claim 1, wherein the user space application comprises a custom stack at and above the transport layer.

3. The method of claim 1, further comprising receiving, by the shim layer, the event comprising a socket file descriptor for the transport layer connection established by the operating system portion of the network stack.

4. The method of claim 3, further comprising including, by the shim layer, the socket file descriptor in a source port of transport layer header in the SYN packet.

5. The method of claim 3, wherein the event comprises an EPOLLIN event from the operating system portion of the network stack.

6. The method of claim 3, further comprising mapping, by the shim layer, tuple information for the transport layer connection established with the user space portion of the network stack via the second transport layer connection handshake.

7. The method of claim 6, wherein the tuple information for the transport layer connection established with the user space portion of the network stack is different than tuple information for the transport layer connection established with the operating system portion of the network stack.

8. The method of claim 3, further comprising identifying, by the shim layer, the socket file descriptor of the transport layer connection established with the operating system portion of the network stack from tuple information of a SYN-ACK packet from the user space application.

9. A method comprising:
establishing, by one or more processors, a shim layer as a network driver for a user space application implementing a user space portion of a network stack of a device, the shim layer using an operating system portion of the network stack of the device providing services at and below a transport layer;
intercepting, by the shim layer, a SYN packet of a first transport layer connection handshake from the user space application to initiate a transport layer connection request with a remote device;
communicating, by the shim layer, a connect call to the operating system portion of the network stack to initiate a second transport layer connection handshake with the remote device in the operating system portion of the network stack;
receiving, by the shim layer, an event from the operating system portion of the network stack, the event indicating a transport layer connection with the remote device has been established by the operating system portion of the network stack via the second transport layer connection handshake, the operating system portion of the network stack having performed the second transport layer connection handshake with the remote device to establish the transport layer connection; and
communicating, by the shim layer responsive to the event, a SYN ACK packet, generated by the shim layer, to the user space application to establish as part of the first transport layer connection handshake the transport layer connection in the user space portion of the network stack.

10. The method of claim 9, further comprising receiving, by the shim layer, an ACK packet from the user space application to complete the first transport layer connection in the user space portion of the network stack.

11. The method of claim 9, further comprising receiving, by the shim layer, the event comprising a socket file descriptor for the transport layer connection established by the operating system portion of the network stack via the second transport layer connection handshake.

12. The method of claim 11, further comprising associating, by the shim layer, the socket file descriptor with tuple information of the SYN or ACK packet from the user space application.

13. The method of claim 9, further comprising receiving, by the shim layer, a PSH-ACK packet of the transport layer connection having data to be communicated to the remote device via the transport layer connection established by the operating system portion of the network stack.

14. The method of claim 13, further comprising generating translated tuple information by translating, by the shim layer, tuple information of the PSH-ACK packet for the transport layer connection with the user space application to tuple information for the transport layer connection used by the operating system portion of the network stack with the remote device.

15. The method of claim 14, further comprising using, by the shim layer based on the translated tuple information, a send call operating system portion of the network stack to send the data via the transport layer connection used by the operating system portion of the network stack with the remote device.

16. A system comprising:
one or more processors, coupled to memory, and configured to:
install a shim layer as a network driver for a user space application implementing a user space portion of a network stack of a device, the shim layer configured to use an operating system portion of the network stack of the device providing services at and below a transport layer;
wherein the shim layer is configured to:
perform a first transport layer connection handshake with the user space application to establish a transport layer connection with a remote device in the user space portion of the network stack;
receive from the operating system portion of the network stack one or more events indicating the transport layer connection was established via a second transport layer connection handshake between the operating system portion of the network stack and the remote device; and
complete, responsive to receiving the one or more events, the first transport layer connection handshake with the user space application.

17. The system of claim 16, wherein the shim layer is further configured to intercept, from the user space application, a SYN packet as part of the first transport layer connection handshake and initiate a connect call to the operating system portion of the network stack to initiate the second transport layer connection handshake.

18. The system of claim 16, wherein the shim layer is further configured to generate a SYN ACK packet and communicate the SYN ACK packet to the user space application to establish as part of the first transport layer connection handshake.

19. The system of claim 16, wherein the shim layer is further configured to:
receive from the user space application a PSH-ACK packet of the transport layer connection having data to be communicated to the remote device via the transport layer connection established by the operating system portion of the network stack;
translate tuple information of the PSH-ACK packet for the transport layer connection with the user space application to tuple information for the transport layer connection used by the operating system portion of the network stack with the remote device; and
send, based on the translated tuple information, the data via the transport layer connection used by the operating system portion of the network stack to the remote device.

20. The system of claim 16, wherein the user space application comprises a custom stack at and above the transport layer, and wherein each of the operating system portion of the network stack and user space application have a transport layer.
